(19) United States
(12) Patent Application Publication
(10) Pub. No.: US 2008/0277837 A1
(43) Pub. Date: Nov. 13, 2008

(54) Gas Permeable Molds

(75) Inventors: Jianxin Liu, North Huntingdon, PA (US); Jeffrey McDaniel, Pittsburgh, PA (US); Michael Rynerson, St. Petersburg, FL (US); Howard Kuhn, Johnstown, PA (US)

Correspondence Address: IP & INTERNET LAW NORTH, LLC, P.O. BOX 38, ZELIENOPLE, PA, 16063, US

(73) Assignee: The Ex One Company, Irwin, PA (US)

(21) Appl. No.: 11/630,190

(22) PCT Filed: Jun. 28, 2004
(86) PCT No.: PCT/US2004/021060

§ 371 Date: Mar. 5, 2007

(51) Int. Cl. B29C 33/10

(52) U.S. Cl. 264/497; 425/405.1

(57) ABSTRACT

Gas permeable molds and mold segments having open porosity (60) are disclosed. Blind vents (56) in the mold wall's (54) outside surface (52) allow for an uninterrupted molding surface (62) while enhancing the gas permeability provided by the open porosity (60). Methods of making such gas permeable molds include forming them from sintered material. Methods also include the use of solid free-form fabrication followed by sintering. Also disclosed are unitary structures (150), for use in EPS bead molding, having a steam chest portion (152) with gas impermeable walls (156) and a mold section (154) having a gas permeable mold wall (172) having open porosity (176), and, optionally, open and/or blind vents (180, 178). Methods for making such unitary structures (150) include the use of solid free-form fabrication.

### TECHNICAL FIELD

The present invention relates to gas permeable molds and methods for making them.

### BACKGROUND ART

Molds consist of two or more opposing segments which are brought together to form a mold cavity in which an article is formed from a moldable material. Gas permeable molds are molds that permit a gas to flow into or out of the mold cavity during the molding operation. Typically, the permeability of the mold to gas flow is achieved by providing the mold with a plurality of vents, distributed over selected portions of the molding surface. For example, molds for making articles from expanded polymer beads like expanded polystyrene (“EPS”) contain a plurality of vents for conducting steam into the mold for causing the polymer beads to further expand and bond together. Injection molding molds contain vents that allow trapped air to escape from the mold during the injection process. Vacuum forming tools, such as those used for thermoforming plastic sheets, contain vents for drawing a vacuum between the tool and the plastic sheet that is to be formed against the tool surface.

The most common way of creating such vents in gas permeable molds is to perform some type of perforation step on the molding surface, e.g., punching or drilling by some mechanical, electrical, optical or chemical means. In the case of EPS bead molds, conventional vent making consists of drilling shouldered holes of between about 0.16 cm and about 0.64 cm main shaft diameter. After these shouldered holes are drilled, cylindrical hardware having slotted end surfaces are press fitted into the holes, and the molding surface is then machined to assure that the hardware is flush with the molding surface.

Conventional vent-making processes are costly and time consuming. Moreover, they restrict the placement of vents to areas that are accessible to the tool that will be used for making the vent. If a vent is required in an otherwise inaccessible area, it is necessary to section the article so that the desired area can be accessed, make the vent or vents in the removed section, and then reintegrate the removed area back into the article. Another drawback is that the vent orientation with respect to the molding surface is restricted by the perforation technique employed and the accessibility of the portion of the surface at which an individual vent is to be placed. Where the surface shape curves or is complex or access is limited, the vent is likely to have a less-than-optimal orientation. Where techniques such as laser or chemical drilling are used, the orientation of the small-diameter fluid conduction vent is usually confined to being nearly perpendicular to the article surface.

In a recent advancement of the art, as described in co-pending patent applications U.S. Pat. Application No. 60/501,981, filed Sep. 11, 2003, of Rynerson et al. and U.S. Pat. Application No. 60/502,068, filed Sep. 11, 2003, of Rynerson et al., solid free-form fabrication is employed to produce gas permeable molds having vents which are formed in situ as the mold itself is constructed in a layer-wise fashion from particulate material. The term “solid free-form fabrication process” as used herein and in the appended claims refers to any process that results in a useful, three-dimensional article and includes a step of sequentially forming the shape of the article one layer at a time from powder. Solid free-form fabrication processes are also known in the art as “layered manufacturing processes.” They are also sometimes referred to in the art as “rapid prototyping processes” or “rapid manufacturing” when the layer-by-layer building process is used to produce a small number of a particular article. A solid free-form fabrication process may include one or more post-shape forming operations that enhance the physical and/or mechanical properties of the article. Preferred solid free-form fabrication processes include the three-dimensional printing (“3DP”) process and the Selective Laser Sintering (“SLS”) process. An example of the 3DP process may be found in U.S. Pat. No. 6,036,777 to Sachs, issued Mar. 14, 2000. An example of the SLS process may be found in U.S. Pat. No. 5,076,869 to Bourell et al., issued Dec. 31, 1991.

In another recent advancement, there has been developed a technique for producing gas permeable molds that eliminates the use of conventional vents. These molds are machined from blocks of partially sintered material that has open porosity. The term “open porosity” as used herein and in the appended claims refers to porosity in a material that is interconnected such that it provides fluid communication through the material. The open porosity in these molds permits gas to pass into and out of the mold cavity through the mold wall. The elimination of the vents from the molding surfaces has advantages. One is that articles made from these molds are free from the nubs or patterns that result from the molding surface vents. Another is that, for operations which mold particulate materials, e.g., EPS bead molding, any particulate size can be used without concern about the particulates flowing out of or clogging the vents.

A drawback to these prior art open-porosity molds is that their gas permeability is primarily dependent on the thickness of the mold wall and of the coarseness and amount of the porosity. Because the porosity weakens the mold, the wall thickness must be increased over what it could be if a solid material were used, but this increased wall thickness reduces the gas permeability. In order to compensate for the increased wall thickness, the coarseness and amount of porosity may be increased. In some applications, an operable balance of strength and permeability may be reached, but, in others, it may not be. Further, the achievement of an operable balance may be at the cost of molding surface smoothness due to the coarseness of the porosity on the molding surface.

### DISCLOSURE OF INVENTION

The present invention includes gas permeable molds and mold segments having smooth, vent-free molding surfaces, but which overcome the drawback of the strict interdependence of mold wall thickness, open porosity coarseness and amount, and gas permeability that burdens prior art methods. These gas permeable molds and mold segments have mold walls having open porosity in which the gas permeability of the open porosity is augmented by that provided by blind vents. The term “blind vent” as used herein and in the appended claims refers to a depression in the outside surface of the mold wall that causes a substantial increase in the gas permeability through the mold wall in the area adjacent to the depression. A blind vent may, but need not be, of similar size and shape as a conventional vent. However, in all cases, blind vents differ from conventional vents in that blind vents do not extend through the molding surface.

The use of blind vents provides several advantages. One, is that the molding surface is uninterrupted, thus avoiding the problem of nubs and vent patterns being formed on the surface of the molded article from where open vents intersect the molding surface of the mold or mold segment. Another is that it allows the coarseness of the open porosity to be reduced and so provides a smoother molding surface without sacrificing gas permeability. Third, it permits the wall thickness to be increased without compromising the mold's or mold segment's gas permeability thereby providing for a stronger and more robust mold or mold segment than is possible in prior art open porosity gas permeable molds and mold segments.

The present invention also includes methods for making such gas permeable molds and mold segments. In preferred embodiments of the present invention, such methods comprise the use of solid free-form fabrication and sintering to construct gas permeable molds and mold segments having open porosity in which the blind vents are built into the mold or mold segment during the solid free-form fabrication. The present invention also includes embodiments wherein the mold or mold segment is machined from sintered blocks having open porosity and one or more blind vents are formed into the outside surface of the mold or mold segment.

The present invention also includes embodiments in which a gas permeable EPS mold segment is part of a unitary structure with a steam chest. A steam chest is a plenum that surrounds a gas permeable EPS mold segment. A steam chest contains one or more ports for selectively conducting gas into or out of the steam chest cavity and the steam chest walls themselves are gas impermeable. The gas permeable EPS mold segment, however, has open porosity. The gas permeability of the gas permeable EPS mold segment may, but need not be, augmented by one or more vents, which may be open or blind vents or a combination of the two. The phrase “open vent” as used herein and in the appended claims refers to a vent that extends uninterrupted through a mold wall from the mold's outer surface to its molding surface. The present invention also includes methods for making such unitary structures in which the unitary structure is built by solid free-form fabrication. In such methods, the steam chest is made gas impermeable by infiltrating it with a solidifiable liquid. The unitary structure embodiments of the present invention have the advantage of utilizing the steam chest to strengthen the gas permeable mold against both the outwardly and the inwardly directed forces that it encounters during the molding operation. In contrast, when the steam chest is not integral with the gas permeable mold segment, it can only brace the gas permeable mold segment against outwardly directed forces.

### BRIEF DESCRIPTION OF DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is schematic cross section of a prior art EPS bead mold system.

FIG. 2A is a top view of a portion of a gas permeable mold according to a preferred embodiment of the present invention.

FIG. 2B is cross sectional view of the mold wall of the gas permeable mold shown in FIG. 2A.

FIG. 3A is a top view of a portion of a gas permeable mold which has blind vents of differing geometric configurations according to a preferred embodiment of the present invention.

FIG. 3B is a cross sectional view of the mold wall of the gas permeable mold shown in FIG. 3A taken along plane 3B-3B.

FIG. 3C is a cross sectional view of the mold wall of the gas permeable mold shown in FIG. 3A taken along plane 3C-3C.

FIG. 4 is a cross sectional view of a unitary structure of a steam chest and a gas permeable mold segment according to a preferred embodiment of the present invention.

### MODES FOR CARRYING OUT THE INVENTION

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims.

The present invention includes among its embodiments gas permeable molds for all applications in which gas permeable molds are used, e.g., for EPS bead molding, for injection molding, for vacuum forming, etc. Likewise, the present invention includes among its embodiments methods for making all such gas permeable molds. However, for clarity of illustration and conciseness, only preferred embodiments which relate to gas permeable molds for EPS bead molding are described. Similarly, while the methods of the present invention which employ solid free-form fabrication can be practiced with any solid free-form fabrication process, e.g., 3DP, SLS, etc., for clarity of illustration and conciseness, only preferred embodiments which employ the 3DP process are described.

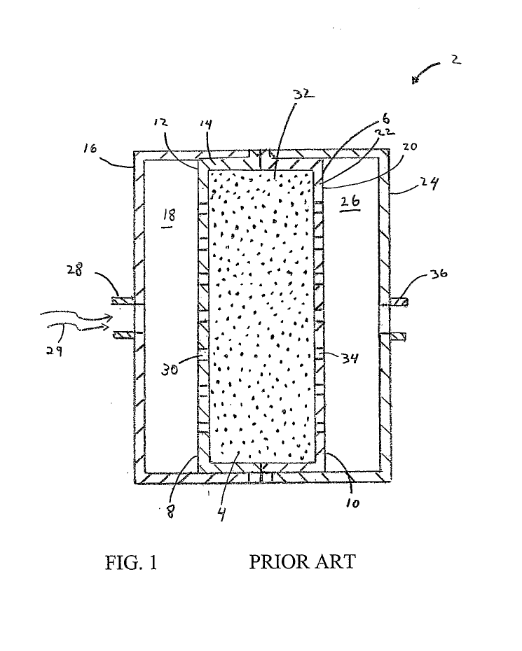

Referring to FIG. 1, in a conventional EPS bead molding system 2, partially-expanded EPS beads 4 are charged into a closed EPS bead mold 6 through an injection port (not shown). The mold 6 consists of a first mold segment 8 and a second mold segment 10. The outer surface 12 of the first mold segment wall 14 and first steam chest 16 define a first steam chest cavity 18. Similarly, the outer surface 20 of the second mold segment wall 22 and the second steam chest 24 define a second steam chest cavity 26. In the flow-through method, the steam 29 is introduced into the first steam chest cavity 18 through first port 28. The steam 29 is conducted through a first plurality of vents 30 in the first segment mold wall 14, passes through the mass of EPS beads 4 in mold cavity 32, a second plurality of vents 34 in second segment mold wall 22, into second chest cavity 26 then out through second port 36. The steam 29 heats the EPS beads 4 causing a blowing agent, such as pentane, within the EPS beads 4 to further expand the EPS beads 4, which then become fused together in the shape defined by the mold 6. After the steaming step is completed, the molded article that formed from the expanded EPS beads 4 is cooled by applying a vacuum to the first and second steam chest cavities 18, 26 and/or by spraying water on the outer surfaces 12, 20 of the mold 6 through spray nozzles (not shown). The mold 6 is then opened and the molded article is removed. An EPS bead molding operation is described in more detail in U.S. Pat. No. 5,454,703 to Bishop, issued Oct. 3, 1995.

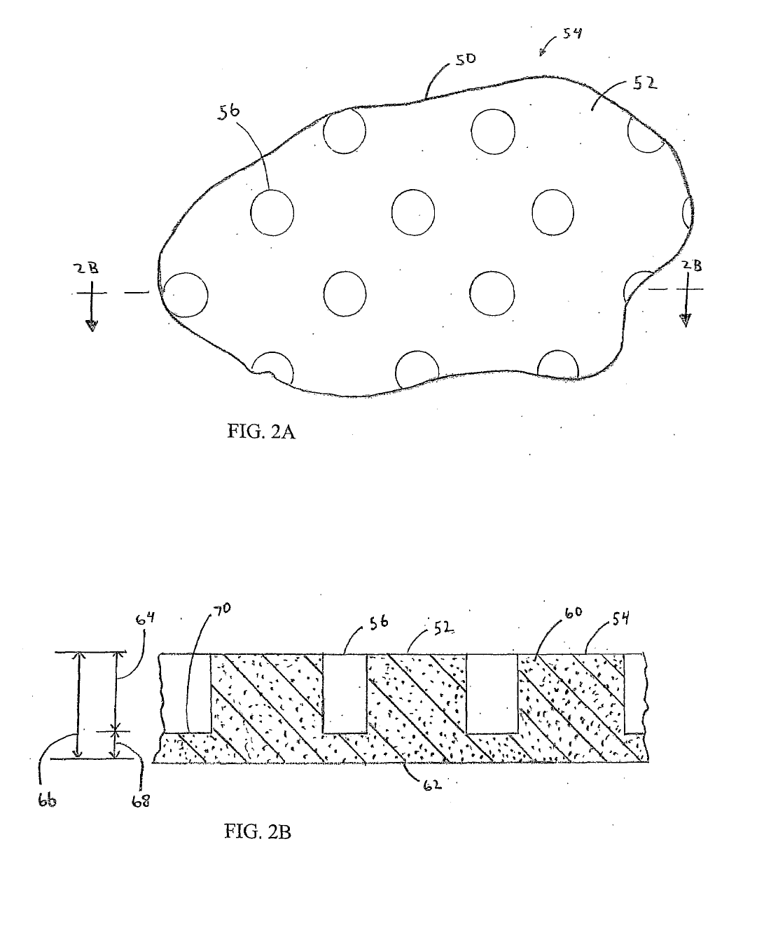

Referring to FIG. 2A, there is shown a portion 50 of the outer surface 52 of a mold wall 54 of a gas permeable EPS mold having blind vents 56, according to a preferred embodiment of the present invention. FIG. 2B shows a cross section of the portion 50 taken along plane 2B-2B. Mold wall 54 has open porosity 60 (indicated by stipling) which provides fluid communication between outer surface 52 and molding surface 62 to allow steam to pass into and out of the mold cavity which molding surface 62 would partly define in use. Blind vents 56 extend from outer surface 52 to a depth 64 of mold wall thickness 66 leaving a blind vent end wall thickness 68 between the bottom 70 of the blind vents 56 and the molding surface 62.

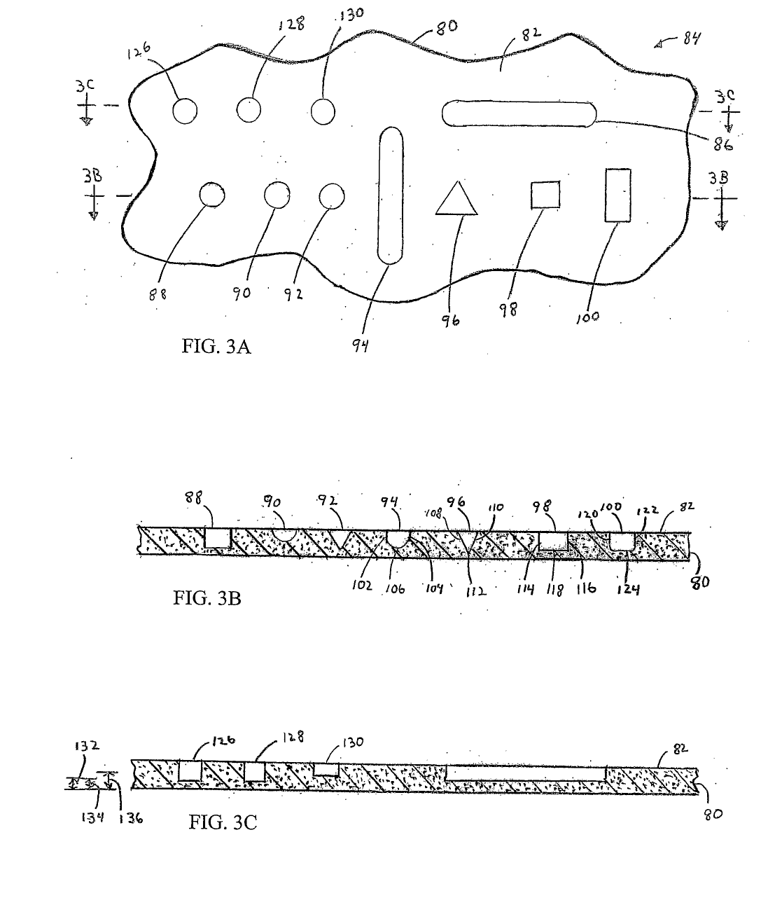

In embodiments of the present invention, the blind vents may have any geometric configuration which provides a substantial local improvement in the gas permeability of the mold wall, and a single gas permeable mold or mold segment may contain vents of differing geometric configurations. FIGS. 3A-3C show a preferred embodiment of the present invention which has blind vents of differing geometric configurations. Referring to FIG. 3A, there is shown a planar portion 80 of an outside surface 82 of a gas permeable mold wall 84 having a plurality of blind vents, which are generally designated by reference number 86. Among the plurality of blind vents 86 are first, second, and third blind vents 88, 90, 92, whose intersection with outside surface 82 is circular; a fourth blind vent 94 whose intersection with outside surface 82 defines an elongated oval; a fifth blind vent 96, whose intersection with outside surface 82 is triangular; a sixth blind vent 98, whose intersection with outside surface 82 defines a square; and a seventh blind vent 100, whose intersection with outside surface 82 defines a rectangle. FIG. 3B shows a cross section of mold wall 84 taken along a plane 3B-3B, which is perpendicular to outside surface 82. FIG. 3B reveals that: the first blind vent 88 is a right cylinder; the second blind vent 90 is hemispherical; and the third blind vent 92 is conical. FIG. 3B also reveals that: the fourth blind vent 94 has parallel side walls 102, 104 and a radiused bottom 106; the slanting walls 108, 110 of the fifth blind vent 96 meet at apex 112; the parallel walls 114, 116 of the sixth blind vent 98 end upon a planar bottom 118; and the opposite walls 120, 122 of the seventh blind vent 100 are radiused where they meet a planar bottom 124.

In embodiments of the present invention, the blind vent end wall thickness, i.e., the mold wall thickness between the interior end of a blind vent and the molding surface, may be of any thickness—or range of thicknesses in the case where the blind vent does not have a bottom that is completely parallel to the molding surface—that provides sufficient local structural integrity to keep the mold wall segment between the interior end of the blind vent and the molding surface intact and continuous during use of the porous mold or mold segment. The blind vent end wall thickness may be the same among all blind vents or vary from blind vent to blind vent for a permeable mold or mold segment. For example, referring to FIG. 3A, there is shown eighth, ninth, and tenth blind vents 126, 128, 130, all of which are right cylinders. FIG. 3C shows a cross section of mold wall 84 taken along plane 3C-3C, which is perpendicular to outside surface 82. Referring to FIG. 3C, it can be seen that the mold wall thickness 132, 134 associated with the eighth and ninth blind vents 126, 128 are the same as each other and different from the mold wall thickness 136 associated with the tenth blind vent 130.

In embodiments of the present invention, the mold wall thickness, the coarseness and amount of open porosity, the number, distribution, and geometric configuration or configurations of the blind vents, and the blind vent end wall thickness or thicknesses in a gas permeable mold or mold segment are determined by consideration of the gas permeability and strength needed for a particular mold or mold segment. In general, these parameters will be determined by applying the principles and knowledge of those skilled in the art applicable to prior art open porosity molds and mold segments. However, in these embodiments, it must be kept in mind that the overall gas permeability of the gas permeable mold or mold segment is the sum of the contributions to gas permeability of the open porosity and of the blind vents. In those embodiments in which open vents are also present, their contribution to gas permeability must also be considered. The mold wall material between the interior end of a blind vent and the molding surface will provide some resistance to gas flow, but substantially less than that of the full mold wall thickness in areas away from the blind vent. The optimum blind vent geometric configuration and the blind vent end wall thickness may be determined by taking into consideration fluid flow analysis combined with fundamental mechanics and chemistry of flow through porous media. For example, it is well known in the field of fluid transport that the efficiency of flow is affected by orifice shape, and the blind vent and the porous material at its end and surrounding it can be viewed as a series and network of interconnecting orifices.

The skilled practitioner may be guided in the making of embodiments of the present invention by measuring the gas permeability of desired mold wall materials having various amounts and courseness levels of open porosity as a function of thickness over the range of pressure differentials expected during the molding operation that the gas permeable mold or mold segment is to be used. Similar guidance will be obtained through the testing of the mechanical strength of desired mold wall materials having various amounts and courseness levels of open porosity as a function of thickness. A four-point loading test of modulus of rupture (MOR) provides a useful measure of such mechanical strength. It is preferred, but not required, that the number, distribution, and geometric configuration of the blind vents be selected so that the mechanical strength is not diminished substantially from the level the permeable mold or mold segment would have without the blind vents.

In all of the embodiments of the present invention which utilize one or more blind vents, it is preferable that the blind vent end wall thickness be in the range of between about 10% and about 70% of the local thickness of the mold wall, i.e., of the through thickness of the mold wall where the blind vent is located. More preferably, the blind vent end wall thickness is in the range of about 20% to about 40% of the local thickness of the mold wall, and, most preferably, it is about 30% of the local thickness of the mold wall.

The mold or mold segment may comprise any material that is known in the art to be suitable for mold making with regard to the application with which the mold or mold segment is to be utilized. For example, the mold material may comprise a metal, ceramic, polymer, or composite material. Preferably, the mold material is a metal selected from the group of aluminum, titanium, nickel, or iron or an alloy containing one or more of these metals. Most preferably, the mold material is a stainless steel powder, e.g., grade 316 or 420.

The present invention also includes methods for making gas permeable molds and mold segments which contain one or more blind vents. In some such method embodiments, the gas permeable molds or mold segments having open porosity are machined from blocks or other forms of a suitable material having open porosity in the manner of the prior art. Blind vents are formed into outer surfaces of such gas permeable molds or mold segments, e.g., by machining, either during or after the machining of the molds or mold segments.

In other such method embodiments, the gas permeable molds or mold segments are pressed and sintered by powder metallurgical methods to their final shape or to a near net shape followed by machining. In these embodiments, some or all of the blind vents may be directly formed during the powder metallurgical operations or they may be formed afterwards, e.g., by machining.

The present invention also includes method embodiments wherein a gas permeable mold or mold segments having open porosity is made by solid free-form fabrication followed by sintering. Although in some of the lesser preferred of these embodiments, one or more blind vents are formed after the free-form fabrication step either prior to or subsequent to the sintering step, in the more preferred embodiments, one or more blind vents are built into the mold or mold segment during the solid free-form fabrication step.

Preferably, the 3DP process is employed as the solid free-form fabrication. The 3DP process is conceptually similar to inkjet printing. However, instead of ink, the 3DP process deposits a binder onto the top layer of a bed of powder. This binder is printed onto the powder layer according to a two-dimensional slice of a three-dimensional electronic representation of the mold or mold segment that is to be manufactured. One layer after another is printed until the entire mold or mold segment has been formed. The powder may comprise a metal, ceramic, polymer, or composite material. Preferably, the powder is metal selected from the group of aluminum, titanium, nickel, or iron or an alloy containing one or more of these metals. Most preferably, the powder is a stainless steel powder, e.g., grade 316 or 420, and has a particle size of −140 mesh/+325 mesh. The binder may comprise at least one of a polymer and a carbohydrate. Examples of suitable binders are given in U.S. Pat. No. 5,076,869 to Bourell et al., issued Dec. 31, 1991, and in U.S. Pat. No. 6,585,930 to Liu et al, issued Jul. 1, 2003.

The gas permeable mold or mold segment after the printing step is a bonded article, typically consisting of from about 30 to over 60 volume percent powder, depending on powder packing density, and about 10 volume percent binder, with the remainder being void space. The printed mold or mold segment is somewhat fragile. The printed mold or mold segment is then sintered at an elevated temperature to enhance its physical and/or the mechanical properties. For example, when the powder used is 316 stainless steel having a particle size of −140 U.S. mesh (106 micron)/+325 U.S. mesh (45 micron), the sintering may be done at 1235° C. in an atmosphere of 50 volume percent hydrogen/50 volume percent argon at 815 torr for 1 hour with heating and cooling rates of about 5° C. per minute.

The making of a mold segment of a gas permeable EPS bead mold segment will now be described according to a preferred method embodiment of the present invention. First, a three-dimensional electronic representation of the mold segment is created as a CAD file and then converted into an STL format file. Next, a CAD file is created of a three-dimensional electronic representation of the array of blind vents that the mold segment is to have. The CAD file of the array of blind vents is then converted into an STL format file.

Persons skilled in the art will recognize that in creating each of the mold segment and blind vent CAD files, the dimensions of both must be adjusted to take into consideration any dimensional changes, such as shrinkage, that may take place during the subsequent sintering step. For example, in order to compensate for shrinkage, a cylindrical blind vent that is to have a final diameter of 0.046 cm may be designed to be printed with a 0.071 cm diameter. The two STL format files are compared to make sure that the individual blind vents will be in desired positions in the mold segment. Any desired corrections or modifications to the STL files may be made thereto. The two STL format files are then combined using a suitable software program that performs a Boolean operation such as binary subtraction operation to subtract the three-dimensional representation of the blind vents from the three-dimensional representation of the mold segment. An example of such a program is the Magics RP software, available from Materialise NV, Leuven, Belgium. Desired corrections or modifications may also be made to the resulting electronic representation, e.g., removing blind vents from areas where they are not wanted.

The file combination step results in a three-dimensional electronic file of the mold segment which contains the desired array of blind vents. A conventional slicing program may be used to convert this electronic file into another electronic file which comprises the mold segment represented as two-dimensional slices. This electronic file may be checked for errors and any desired corrections or modifications may be made thereto, and is then employed by a 3DP process apparatus to create a printed version of the mold segment. An example of such a 3DP process apparatus is a ProMetal® Model RTS 300 unit that is available from Extrude Hone Corporation, Irwin, Pa. 15642.

The method disclosed in the preceding paragraphs for producing an electronic representation of a gas permeable mold segment utilizable by a solid free-form fabrication device is only one of many ways to make such an electronic representation. The exact method used is up to the discretion of the designer and will depend upon factors such as the complexity and size of the mold segment, the size and number of the blind vents, the computer processing facilities that are available, and the amount of computational time that is available for processing the electronic file or files. For example, in some cases it may be expeditious to include the blind vents into the initial CAD file as part of the three-dimensional electronic representation of the gas permeable mold segment. In other cases, it may be desirable to eliminate the step of comparing the STL files of the blind vent array and of the mold segment prior to combining the two files.

The present invention also includes embodiments in which a gas permeable EPS bead mold segment and a steam chest comprise a unitary structure. The gas permeable mold segment part of the unitary structure has open porosity and the gas permeability of its mold wall may, but need not be, augmented by one or more vents, which may be open or blind vents or a combination of the two. The steam chest part of the unitary structure is impermeable to the process gases used in the EPS bead molding operation.

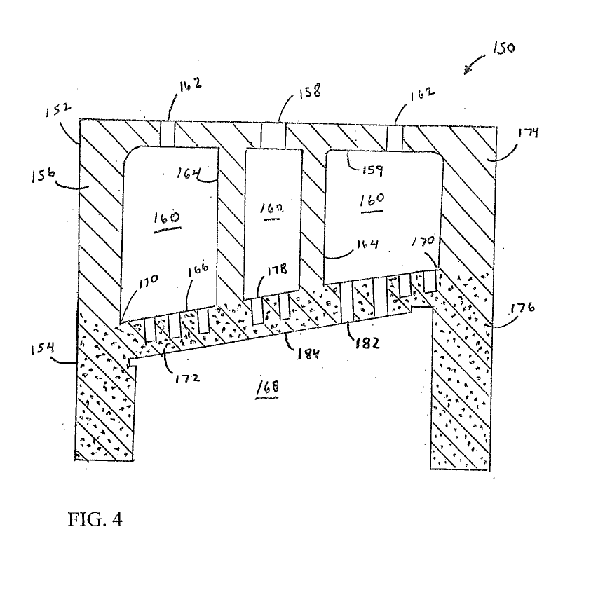

FIG. 4 shows a cross section of a unitary steam chest/gas permeable mold segment structure 150. Unitary structure 150 comprises a steam chest portion 152 and a gas permeable mold segment portion 154. The steam chest portion 152 has walls 156 which have been infiltrated with a solidifiable liquid to make them impermeable to the gases used during the EPS bead molding process. The steam chest portion 152 has a gas port 158 for introducing and removing process gases into and from the steam chest cavity 160. The steam chest portion 152 also has water ports 162 for inserting controllable water jets (not shown) that may be used during the molding process to cool the gas permeable mold segment portion 154. Stanchions 164 extend between the steam chest portion outer wall 159 and the outer surface 166 of the gas permeable mold segment portion mold wall 172. The stanchions 164 enable the steam chest portion 152 to strengthen the mold wall 172 against forces directed both inwardly to and outwardly from the mold cavity 168 during the molding operation. The stanchions 164 are preferably infiltrated like walls 156 to enhance their strength.

The periphery 170 of mold wall 172 of the gas permeable mold segment portion 154 intersects the steam chest portion 152. Although the mold wall 172 near its periphery 170 may contain some infiltrant 174 (indicated by hatching that lacks stipling), generally mold wall 172 has open porosity 176 (indicated by stipling). Preferably, mold wall 172 also has a plurality of blind vents 178, which extend inwardly from its outer surface 166, to augment the gas permeability provided by the open porosity 176. Mold wall 172 may also have one or more open vents 180 to provide additional gas permeability. However, open vents 180 are less desirable than blind vents 178 because open vents 180 interrupt the continuity of the molding surface 182, thus causing surface imperfections in the molded article.

The present invention also includes method embodiments for making unitary steam chest/gas permeable mold segment structures. In these embodiments, the unitary structure is constructed by solid free-form fabrication. The unitary structure is then sintered to strengthen the gas permeable mold segment portion to the level necessary for use. The unitary structure is then heated in the presence of a solidifiable liquid infiltrant so that the infiltrant infiltrates the steam chest portion, while maintaining the mold wall of the gas permeable mold segment portion generally free of infiltrant. The unitary structure is then cooled to solidify the infiltrant. Light machining may be employed to clean up the surfaces or to otherwise finish the construction of the unitary structure.

In a preferred embodiment, the powder used is either 316 stainless steel or 420 stainless steel having a particle size in the range of about −140 U.S. mesh (106 microns)/+325 U.S. mesh (45 microns) and the infiltrant is a bronze, more preferably a bronze containing about 90 weight percent copper and about 10 weight percent tin. However, the powder may comprise any suitable metal, ceramic, polymer, or composite material. Preferably, the powder is a metal selected from the group of aluminum, titanium, nickel, or iron or an alloy containing one or more of these metals. The infiltrant is preferably a molten metal or metal alloy that wets the powder well, is liquid below the softening point of the powder, and solidifies at a temperature that is above the highest processing temperature which the unitary structure is expected to reach during the EPS bead molding process.

While only a few embodiments of the present invention have been shown and described, it will be obvious to those skilled in the art that many changes and modifications may be made thereunto without departing from the spirit and scope of the invention as described in the following claims. All United States patents and United States patent applications referred to herein are incorporated herein by reference as if set forth in full herein.

1. An article for use as a mold or a mold segment, said article comprising:
a) a gas permeable mold wall, said mold wall containing open porosity and having a molding surface and an outer surface, said open porosity providing fluid communication between said molding surface and said outer surface; and
b) a plurality of blind vents, each blind vent of said plurality extending into said mold wall and having an open end on said outer surface and an interior surface defined by said mold wall, said interior surface being in fluid communication with said molding surface through said open porosity;
wherein gas flow through said mold wall comprises gas flow through said open ends and gas flow through said outer surface.

2. The article described in claim 1, wherein said article is an EPS bead mold or mold segment.

3. The article described in claim 1, wherein said article is an injection mold or mold segment.

4. The article described in claim 1, wherein said article is a vacuum forming mold or mold segment.

5. The article of claim 1, wherein at least one blind vent of said plurality of blind vents is cylindrical in shape.

6. The article described in claim 1, wherein at least one blind vent of said plurality of blind vents has a blind vent end wall thickness that is in the range of between about 10% and about 70% of the local thickness of said mold wall.

7. The article described in claim 1, wherein said blind vent end wall thickness is in the range of between about 20% and about 40% of the local thickness of said mold wall.

8. The article described in claim 1, wherein said mold wall comprises at least one selected from the group consisting of a metal, a ceramic, a polymer, and a composite material.

9. The article described in claim 1, wherein said mold wall comprises a metal selected from the group consisting of aluminum, titanium, nickel, iron, and alloys thereof.

10. The article described in claim 1, wherein said mold wall comprises a stainless steel.

11. The article described in claim 10, wherein said stainless steel is selected from the group consisting of 316 stainless steel and 420 stainless steel.

12. An article for use in EPS bead molding comprising a unitary structure having a steam chest portion and a mold section, wherein said steam chest portion has an outer wall which is impermeable to EPS bead molding process gases, and said mold section has a mold wall, said mold wall having a molding surface, an outer surface, and open porosity, said open porosity providing fluid communication between said outer surface and said molding surface.

13. The article described in claim 12, wherein said mold wall has a plurality of blind vents extending into it from its outer surface.

14. The article described in claim 12, wherein said mold wall has at least one open vent.

15. The article described in claim 12, wherein said outer wall comprises a metal selected from the group consisting of aluminum, titanium, nickel, iron, and alloys thereof.

16. The article described in claim 12, wherein said outer wall comprises stainless steel.

17. The article described in claim 16, wherein said stainless steel is selected from the group consisting of 316 stainless steel and 420 stainless steel.

18. The article described in claim 12, wherein said outer wall comprises a solidified infiltrant material.

19. The article described in claim 18, wherein said solidified infiltrant material comprises a bronze.

20. The article described in claim 12, further comprising at least one stanchion extending between said outer wall and said mold wall.

21. A method for making an article for use as a mold or mold segment, said method comprising the steps of:
(a) designing said article to have a mold wall, said mold wall having a molding surface, an outer surface open porosity, and blind vents, said open porosity providing fluid communication between said mold wall and said outer surface and each of said blind vents extending into said mold wall and having an open end on said outer surface and an interior surface defined by said mold wall, said interior surface being in fluid communication with said molding surface through said open porosity; and
(b) fabricating said article by a solid free-form fabrication process.

22. The method described in claim 21, wherein the step of designing includes machining the steps of:
(c) creating an electronic three-dimensional representation of said article absent said blind vents;
(d) creating an electronic three-dimensional representation of said blind vents; and
(e) combining said electronic representations of said article without said blind vents with said electronic representation of said blind vents to create an electronic representation of said article.

23. The method described in claim 21, wherein the step of designing includes designing said article to permit gas flow through said mold wall to comprise gas flow through said open ends and said outer surface.

24. The method described in claim 21, further comprising the step of machining at least one additional blind vent of into said outer surface after said solid free-form fabrication process has been completed.

25. (canceled)

26. The method described in claim 21, wherein said solid free-form fabrication process is 3DP.

27. The method described in claim 21, wherein said solid free-form fabrication process is SLS.

28. The method described in claim 21, wherein said solid free-form fabrication process produces a bonded mold wall, said method further comprising the step of sintering said bonded mold wall at an elevated temperature.

29. The method described in claim 21, wherein said solid free-form fabrication process includes the use of at least one powder selected from the group consisting of a metal, a ceramic, a polymer, and a composite material for making said mold wall.

30. The method described in claim 21, wherein said solid free-form fabrication process includes the use of a powder of a metal selected from the group consisting of aluminum, titanium, nickel, iron, and alloys thereof for making said mold wall.

31. The method described in claim 21, wherein the solid free-form fabrication process includes the use of a stainless steel powder for making said mold wall.

32. The method described in claim 31, wherein said stainless steel powder is selected from the group consisting of 316 stainless steel and 420 stainless steel.

33. The method described in claim 21, wherein said solid free-form fabrication process includes the use of a powder having a particle size of between about 45 microns and about 106 microns for making said mold wall.

34. The method described in claim 21, wherein at least one blind vent of said plurality of blind vents has a cylindrical shape.

35. The method described in claim 21, wherein at least one blind vent of said plurality of blind vents has a blind vent end wall thickness that is in the range of between about 10% and about 70% of the local thickness of said mold wall.

36. The method described in claim 21, wherein said blind vent end wall thickness is in the range of between about 20% and about 40% of the local thickness of said mold wall.

37. A method for making an article for use in EPS bead molding, said article having a unitary structure including a steam chest portion and a mold section, said method comprising the step of making a preform of said unitary structure by a solid free-form fabrication process.

38. The method described in claim 37, further comprising the step of sintering said preform at an elevated temperature.

39. The method described in claim 38, further comprising the step of infiltrating an outer wall of said steam chest portion with a solidifiable liquid.

40. The method described in claim 39, further comprising the step of solidifying the infiltrated solidifiable liquid.

41. The method of claim 39, wherein said solidifiable liquid comprises a molten bronze.

42. The method described in claim 37, wherein said mold section has a mold wall, said mold wall having an outer surface, a molding surface, and open porosity, said open porosity providing fluid communication between said outer surface of said mold wall and a molding surface of said mold wall.

43. The method described in claim 42, wherein the step of making a preform includes forming a plurality of blind vents into said outer surface of said mold wall.

44. The method described in claim 43, wherein at least one blind vent of said plurality of blind vents has a cylindrical shape.

45. The method described in claim 43, wherein at least one blind vent of said plurality of blind vents has a blind vent end wall thickness that is in the range of between about 10% and about 70% of the local thickness of said mold wall.

46. The method described in claim 43, wherein said blind vent end wall thickness is in the range of between about 20% and about 40% of the local thickness of said mold wall.

47. The method described in claim 42, wherein the step of making a preform includes forming at least one open vent through said mold wall.

48. The method described in claim 42, wherein said steam chest portion having an outer wall and said article has at least one stanchion extending between said outer wall and said mold wall.

49. The method described in claim 42, wherein the solid free-form fabrication includes the use of at least one powder selected from the group consisting of a metal, a ceramic, a polymer, and a composite material for making said mold wall.

50. The method described in claim 42, wherein the solid free-form fabrication includes the use of a powder of a metal selected from the group consisting of aluminum, titanium, nickel, iron, and alloys thereof for making said mold wall.

51. The method described in claim 42, wherein said solid free-form fabrication process includes the use of a stainless steel powder for making said mold wall.

52. The method described in claim 51, wherein said stainless steel powder is selected from the group consisting of 316 stainless steel and 420 stainless steel.

53. The method described in claim 42, wherein said solid free-form fabrication process includes the use of a powder having a particle size of between about 45 microns and about 106 microns for making said mold wall.

54. The method of claim 37, wherein said solid free-form fabrication process is 3DP.

55. The method described in claim 37, wherein said solid free-form fabrication process is SLS.
